(19) United States
(12) Patent Application Publication
(10) Pub. No.: US 2025/0323960 A1
(43) Pub. Date: Oct. 16, 2025

(54) MESSAGE PROCESSING METHODS, APPARATUS, COMMUNICATION DEVICES, STORAGE MEDIA, AND PROGRAM PRODUCTS

(71) Applicant: DOUYIN VISION (BEIJING) CO., LTD., Shijingshan District, Beijing (CN)

(72) Inventors: Yixu WANG, Beijing (CN); Xu YANG, Beijing (CN)

(21) Appl. No.: 18/869,395

(22) PCT Filed: Jun. 13, 2023
(86) PCT No.: PCT/CN2023/099950

§ 371 Date: Nov. 26, 2024

(30) Foreign Application Priority Data
Jun. 16, 2022 (CN) 202210689078.3

(51) Int. Cl. H04L 65/403; H04L 65/1069; H04L 65/1076

(52) U.S. Cl. CPC H04L 65/403; H04L 65/1069; H04L 65/1076

(57) ABSTRACT

This disclosure relates to a message processing method and apparatus, a communication device, a storage medium, and a program product. The method comprises: receiving a target message sent by a server, the target message comprising: an invitation message for indicating that a second client invites the first client to join a live interaction; acquiring a remaining valid duration corresponding to the invitation message based on time information carried in the target message; in response that the remaining valid duration is greater than or equal to a first duration threshold, displaying the invitation message to send a reply message based on the invitation message, wherein the reply message indicates whether to agree to join a live interaction with the second client; and in response that the remaining valid duration is less than the first duration threshold, ignoring the invitation message.

### CROSS-REFERENCE TO RELATED APPLICATIONS

The present disclosure is based on and claims priority of Chinese Patent Application No. 202210689078.3, filed on Jun. 16, 2022, the disclosure of which is hereby incorporated by reference in its entirety.

### TECHNICAL FIELD

This disclosure relates to the technical field of live streaming, and specifically to a message processing method, apparatus, a communication device, a storage medium, and a program product.

### BACKGROUND

At present, with the development of live streaming technology, a form of livestreaming has emerged that allows two streamers to perform together via a video chat, making the images and sounds accessible to the funs of both livestreams, hereinafter referred to as “live interaction”. The process of establishing a live interaction may include sending an invitation message from client A corresponding to livestream A to client B corresponding to livestream B to indicate the establishment of a live interaction. Upon receiving the invitation message, client B sends a reply message to client A to indicate agreement to join a live interaction. Upon receiving the reply message, client A joins a live interaction with client B.

### SUMMARY

According to a first aspect of some embodiments of the present disclosure, there is provided a message processing method applicable to a first client, comprising: receiving a target message sent by a server, the target message comprising: an invitation message for indicating that a second client invites the first client to join a live interaction; acquiring a remaining valid duration corresponding to the invitation message based on time information carried in the target message; in response that the remaining valid duration is greater than or equal to a first duration threshold, displaying the invitation message to send a reply message based on the invitation message, wherein the reply message indicates whether to agree to join a live interaction with the second client; and in response that the remaining valid duration is less than the first duration threshold, ignoring the invitation message.

According to a second aspect of some embodiments of the present disclosure, there is provided a message processing method applicable to a second client, comprising: sending an invitation message to a server, wherein the invitation message indicates that the second client invites a first client to join a live interaction; wherein the invitation message is used by the server to send a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; and in response that the remaining valid duration is less than the first duration threshold, the invitation message is ignored.

According to a third aspect of some embodiments of the present disclosure, there is provided a message processing method applicable to a server, comprising: receiving an invitation message sent by a second client, wherein the invitation message indicates that the second client invites a first client to join a live interaction; sending a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; and in response that the remaining valid duration is less than the first duration threshold, the invitation message is ignored.

According to a fourth aspect of the embodiments of the present disclosure, there is provided a message processing apparatus, comprising: a receiving module, an acquiring module, and a processing module. The receiving module is used for receiving a target message sent by a server, the target message comprising: an invitation message for indicating that a second client invites a first client to join a live interaction; the acquiring module is used for acquiring a remaining valid duration corresponding to the invitation message based on time information carried in the target message that is received by the receiving module; and the processing module is used for, in response that the remaining valid duration acquired by the acquiring module is greater than or equal to a first duration threshold, displaying the invitation message and sending a reply message based on the invitation message, the reply message being used to indicate whether to agree to join a live interaction with the second client; and in response that the remaining valid duration acquired by the acquiring module is less than the first duration threshold, ignoring the invitation message.

According to a fifth aspect of the embodiments of the present disclosure, there is provided a message processing apparatus, comprising: a sending module for sending an invitation message to a server, wherein the invitation message indicates that a second client invites a first client to join a live interaction; wherein the invitation message is used by the server to send a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; and in response that the remaining valid duration is less than the first duration threshold, the invitation message is ignored.

According to a sixth aspect of the embodiments of the present disclosure, there is provided a message processing apparatus, comprising: a receiving module and a sending module; wherein the receiving module is used for receiving an invitation message sent by a second client, the invitation message being used to indicate that the second client invites a first client to join a live interaction; and the sending module is used for sending a target message to the first client based on the invitation message, the target message being used to enable the first client to acquire a remaining valid duration corresponding to the invitation message based on time information carried in the target message; wherein in response that the remaining valid duration is greater than or equal to a first duration threshold, the invitation message is displayed; and in response that the remaining valid duration is less than the first duration threshold, the invitation message is ignored.

According to a seventh aspect of the embodiments of the present disclosure, there is provided a communication device, comprising a processor, a memory, and a computer program which is stored in the memory and executable on the processor, wherein when the communication device is a first client, the computer program, when executed by the processor, implements the message processing method according to the first aspect; when the communication device is a second client, the computer program, when executed by the processor, implements the message processing method according to the second aspect; when the communication device is a server, the computer program, when executed by the processor, implements the message processing method according to the third aspect.

According to an eighth aspect of the embodiments of the present disclosure, there is provided a computer-readable storage medium on which a computer program is stored, wherein the computer program, when executed by a processor, implements the message processing method according to the first, second or third aspect.

According to a ninth aspect of the embodiments of the present disclosure, there is provided a computer program product, the computer program product comprising a computer program that, when running on a processor, causes the processor to execute the computer program to implement the message processing method according to the first, second or third aspect.

According to a tenth aspect of the embodiments of the present disclosure, there is provided a chip comprising a processor and a communication interface coupled to the processor, the processor being used to execute program instructions to implement the message processing method according to the first, second or third aspect.

According to an eleventh aspect of the embodiments of the present disclosure, there is provided a computer program, comprising: instructions, wherein the instructions when executed by a processor, cause the processor to perform the message processing method according to the first, second or third aspect.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a schematic flowchart of a message processing method provided by embodiments of the present disclosure;

FIG. 2 is a first structural diagram of a message processing apparatus provided by embodiments of this disclosure;

FIG. 3 is a second structural diagram of the message processing apparatus provided by embodiments of this disclosure;

FIG. 4 is a third structural diagram of the message processing apparatus provided by embodiments of this disclosure;

FIG. 5 is a structural diagram of a communication device provided by embodiments of the present disclosure.

### DETAILED DESCRIPTION

In order to better understand the above purposes, features and advantages of the present disclosure, the technical solution of the present disclosure will be further described below. It should be noted that, in response to no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

It should be noted that the terms “first”, “second” and the like in the description and claims of the present disclosure are used to distinguish similar objects, and are not necessarily used to describe a specific order or sequence. It should be understood that the terms so used may be interchanged where appropriate so that the embodiments of the disclosure described herein can be implemented in an order other than those illustrated or described herein. In addition, the objects distinguished by “first”, “second”, etc. are typically of the same type, without limitation as to the number of objects. For example, the first object may be one or more objects. In addition, in the description and claims, the word “and/or” represents at least one of the associated objects, and the character “/” generally indicates that the associated objects before and after “/” have an “or” relationship.

In the live interaction mechanism in related technologies, the inviter has a 20-second invitation countdown logic. Specifically, within 20 seconds after sending an invitation message (“invite”), the user cannot invite other users to join. If a reply message (“reply”) is received from the invitee within 20 seconds, the invitation countdown is canceled, and if a reply message is received indicating that the invitation is accepted, a live interaction is established with the invitee; if no reply message is received from the invitee within 20 seconds, it is deemed that this video chat invitation has timed out. The inviter calls a cancellation interface (“cancel”) to notify the server, and the server sends a cancellation message to the invitee. The invitee then closes a pop-up invitation window. The invitee has a 10 second countdown logic for acceptance. Specifically, if the user clicks an Accept or Reject button within 10 seconds of receiving the invitation message, a reply request is sent directly; if no response is received within 10 seconds, the invitation is automatically rejected.

However, in complex network and device environments (such as international network and device environments), it is easy to cause a high delay in the arrival time of livestream messages (for example, livestream messages need to pass through a central data center during transmission, and if the distance between the central data center and other servers is large, it will cause a significant delay in the transmission of livestream messages), thereby reducing the successful rate of live interaction establishment.

Big Data statistics show that in complex network and device environments, 95% of users have 15 seconds left in the 20-second countdown when an invitation message reaches the invitee. As long as the invitee user accepts the invitation before the 10-second countdown timeout, a reply message can reach the inviter before the 20-second countdown timeout. However, for the remaining 5% of users, by the time the invitation message reaches the invitee, the invitation message may have timed out or be about to expire. If the user accepts the invitation before the 10-second countdown timeout, the reply message may not reach the inviter before the 20-second countdown timeout, resulting in a failed live interaction and affecting the user experience.

That is to say, in the process of establishing a live interaction, due to the poor timeliness of invitation and reply messages, there may be a long delay in the transmission process. The livestream video chat mechanism in related technologies allows the inviter (client A) to wait for a maximum of 20 seconds (i.e. the invitation message is valid within 20 seconds of the invitation message being sent from the time when the invitation message is sent, and expires after 20 seconds). If no response is received from the invitee (user device B) within 20 seconds, the livestream video chat is directly cancelled due to the expiration of the invitation message. Therefore, there is a situation where the invitee receives an invitation message and sends a reply message to the inviter. However, before the reply message reaches the inviter, the inviter cancels the livestream video chat due to the expiration of the invitation message, resulting in the unsuccessful establishment of the livestream video chat and degrading the user experience of the invitee.

Therefore, there is a problem with the related technology that, due to the long delay in the transmission of invitation and/or reply messages, the livestream video chat cannot be successfully established even if the invitee agrees to accept the livestream video chat invitation, resulting in poor user experience.

In view of this, in embodiments of the present disclosure, a target message sent by a server can be received; based on time information carried by the target message, a remaining valid duration corresponding to the invitation message is obtained; in response that the remaining valid duration is greater than or equal to a first duration threshold, the invitation message is displayed; and in response that the remaining valid duration is less than the first duration threshold, the invitation message is ignored. That is, whether to display or ignore the invitation message is determined based on the remaining valid duration corresponding to the invitation message. In this way, in response that the invitation message is already invalid (expired) or about to become invalid (the remaining valid duration is less than the first duration threshold), even if the invitee user agrees to join a live interaction, the invitation message will be ignored, i.e., the invitation message will not be displayed because the livestream video chat cannot be successfully established as the reply message cannot reach the inviter within the valid duration of the invitation message, which can achieve the effect of not disturbing the user when the invitation message is about to expire. In response that the remaining valid duration of the invitation message is greater than or equal to the first duration threshold, that is, in response that the reply message can reach the inviter within the valid duration of the invitation message, the invitation message is displayed, so that the user can decide according to the invitation message whether to agree to the livestream video chat, thus further improving the user experience.

In embodiments of the present disclosure, the first and second clients can be electronic devices such as mobile phones, tablets, laptops, handheld computers, in-vehicle electronic devices, wearable devices, personal computers (PCs), televisions (TVs), etc. Wherein, the first client is an invitee client, and the second client is an inviter client.

Below, with reference to the accompanying drawings, a detailed explanation of the message processing method provided in the present disclosure will be provided based on a specific embodiment and its application scenario.

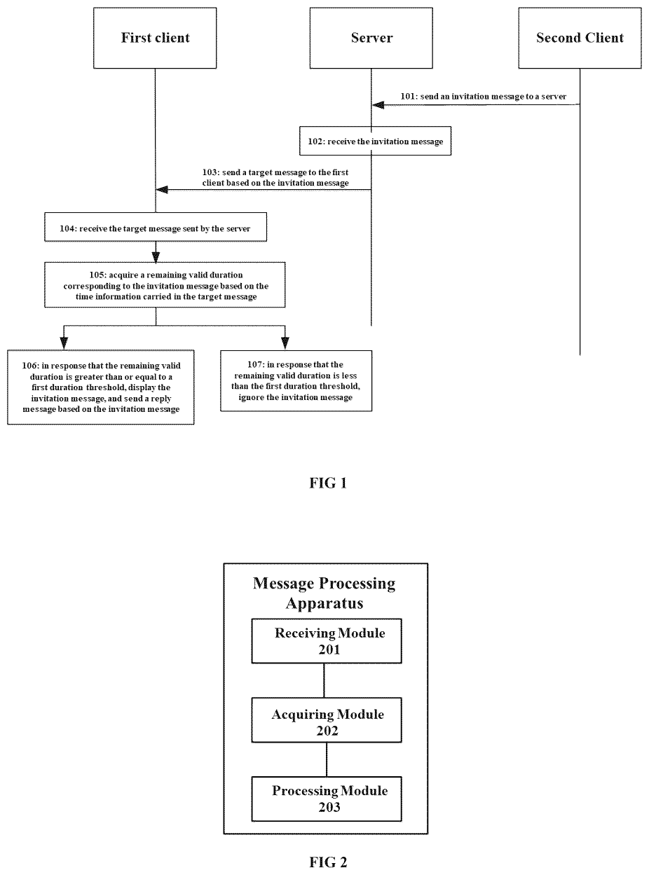

As shown in FIG. 1, embodiments of the present disclosure provide a message processing method, which may include steps 101 to 107 as follows.

101: a second client sends an invitation message to a server.

Wherein, the invitation message indicates that a second client invites a first client to join a live interaction.

102: the server receives the invitation message.

103: the server sends a target message to the first client based on the invitation message.

For example, the target message may be the invitation message or a message generated by the server based on the invitation message.

In some embodiments, the server generates a target message based on the invitation message and sends the target message to the first client.

Wherein, the target message enables the first client to acquire a remaining valid duration corresponding to the invitation message based on time information carried in the target message. In response that the remaining valid duration is greater than or equal to a first duration threshold, the invitation message is displayed, and in response that the remaining valid duration is less than the first duration threshold, the invitation message is ignored.

In some embodiments, the time information may be generated by the second client based on the time when the invitation message was sent by the second client and a total valid duration of the invitation message, or by the server based on the total valid duration of the invitation message, which can be determined according to practical situations and is not limited here.

In some embodiments, in response that the time information is generated by the server based on the total valid duration of the invitation message, it can be generated by the server based on the time when the second client sends the invitation message and a total valid duration of the invitation message, or it can be generated by the server based on the time when the server receives the invitation message and the total valid duration of the invitation message, or it can be generated by the server based on the time when the server receives the invitation message and the total valid duration of the invitation message, as well as the time when the server sends the target message, or it can be generated by the server based on other information, which can be determined according to practical situations and is not limited here.

Wherein, the total valid duration of the invitation message can be carried in the invitation message, or it can be a preset duration, which can be determined according to practical situations and is not limited here.

104: the first client receives the target message sent by the server.

Wherein, the target message includes an invitation message for indicating that the second client invites the first client to join a live interaction.

105: the first client acquires a remaining valid duration corresponding to the invitation message based on the time information carried in the target message.

106: in response that the remaining valid duration is greater than or equal to a first duration threshold, the first client displays the invitation message, and sends a reply message based on the invitation message.

Wherein, the reply message indicates whether to agree to join a live interaction with the second client.

Wherein, the first duration threshold can be determined based on actual situations, and is not limited here. For example, the first duration threshold can be half of the total valid duration of the invitation message, or a quarter of the total valid duration. For example, the total valid duration is 20 s, and the first duration threshold is 5 s.

In some embodiments, the reply message can be a Hypertext Transfer Protocol (HTTP) reply message, a Real Time Communication (RTC) reply message, or in other forms, which can be determined according to practical situations and is not limited here. Wherein, the transmission of RTC reply messages is generally faster, and thus sending a RTC reply message can further improve the successful rate of livestream video chat establishment and improve the user experience. Moreover, a HTTP reply message and a RTC reply message can be sent separately as a complement to each other, further ensuring that a livestream video chat can be successfully established.

107: in response that the remaining valid duration is less than the first duration threshold, the first client ignores the invitation message.

It can be understood that, whether to display or ignore the invitation message is determined based on the remaining valid duration corresponding to the invitation message. In this way, in response that the invitation message is already invalid (expired) or about to become invalid (the remaining valid duration is less than the first duration threshold), even if the invited user agrees to join a live interaction, the invitation message will be ignored, i.e., the invitation message will not be displayed because the livestream video chat cannot be successfully established as the reply message cannot reach the inviter within the valid duration of the invitation message, which can achieve the effect of not disturbing the user when the invitation message is about to expire. In response that the remaining valid duration of the invitation message is greater than or equal to the first duration threshold, that is, in response that the reply message can reach the inviter within the valid duration of the invitation message, the invitation message is displayed, so that the user can decide according to the invitation message whether to agree to the livestream video chat, thus further improving the user experience.

In some embodiments, the time information includes an expiration time of the invitation message and a first sending time at which the target message is sent by the server. The above step 105 can be specifically implemented as the following step 105a.

105a: determine the remaining valid duration based on the expiration time and the first sending time.

Wherein, the expiration time is obtained by the server based on a total valid duration of the invitation message and a first receiving time at which the invitation message is received by the server.

Wherein, the first sending time is the time at which the server sends the target message to the first client.

It can be understood that the remaining valid duration can be a first difference between the expiration time and the first sending time at which the target message is sent by the server, or a difference between the first difference (i.e., the difference between the expiration time and the first sending time at which the target message is sent by the server) and a first preset duration, or a product of the first difference and a preset value. The preset value is greater than 0 but less than 1, and can be determined according to actual situations.

It can be understood that in the transmission process of the invitation message, the transmission delay is mainly caused by the server processing the message and waiting for message transmission after receiving the message, resulting in the remaining valid duration of the invitation message when reaching the first client being less than the first time threshold. Therefore, the remaining valid duration can be the first difference between the expiration time and the first sending time.

In embodiments of the present disclosure, the remaining valid duration is calculated based on the time of the server, which can avoid the problem of inaccurate calculation of the remaining valid duration due to inconsistent timing (time standards) between the first and second clients.

In some embodiments, the above step 105a can be specifically implemented as the following step 105a1.

105a1: determine the remaining valid duration based on the expiration time, the first sending time, and the first preset duration.

Wherein, the first preset duration can be determined based on actual situations, and is not limited here.

It can be understood that the remaining valid duration is the difference between the first difference (i.e., the difference between the expiration time and the first sending time at which the target message is sent by the server) and the first preset duration.

Wherein, the first preset duration is statistically the average duration between the time when the server sends a first message to the first client and the time when the first client receives the first message. The first preset duration can be updated periodically to ensure the accuracy of the first preset duration.

Wherein, the first message can be any message transmitted between the first client and the server, or it can be a message of the same type as the target message transmitted between the first client and the server.

It can be understood that the server includes a business service module for processing business and a message sending and receiving module (such as an instant messaging module) for sending and receiving messages. The first sending time described above is the time when the message sending and receiving module sends the target message. The first preset duration described above is statistically the average duration between the time when the message sending and receiving module sends the first message and the time when the first client receives the first message in history, indicating the time taken from the message sending and receiving module sending the target message to the first client receiving the target message.

It should be noted that the time taken from the message sending and receiving module sending the first message (target message) to the first client receiving the first message (target message) is generally short, usually a few hundred milliseconds, and can therefore be ignored. That is to say, the first duration threshold is relatively small, which has little effect on the calculation of the remaining valid duration.

In embodiments of the present disclosure, the remaining valid duration is determined based on the expiration time, the first sending time, and the first preset duration, which can ensure that the calculated remaining valid duration is more accurate, thereby increasing the probability of success in livestream video chats and improving the user experience.

In some embodiments, the server obtains the expiration time based on the total valid duration, a first receiving time, and a second preset duration. The second preset duration is statistically the average duration between the time the second client sends a second message to the server and the time the server receives the second message.

Wherein, the second message can be any message transmitted between the second client and the server, or it can be a message of the same type as the invitation message transmitted between the second client and the server.

Wherein, the total valid duration can be fixed (a preset standard duration) or dynamically configured (determined by the second client according to actual situations and carried in the invitation message), which is determined according to actual situations and is not limited here.

It can be understood that the expiration time can be the sum of the total valid duration and the first receiving time, or it can also be the difference between the above sum and the second preset duration.

For example, after step 102, step 103 can be specifically implemented as steps 108 to 109 below.

108: the server determines the expiration time based on the total valid duration and the first receiving time.

109: the server sends a target message to the first client based on the invitation message, the expiration time, and the first sending time.

In embodiments of the present disclosure, the expiration time is calculated by the server to avoid the problem of inaccurate calculation of the remaining valid duration due to inconsistent timings on the first and second clients.

In some embodiments, the expiration time can be the sum of the first receiving time and the total valid duration, or the above sum minus a second duration threshold.

Wherein, the above step 109 can specifically include the service generating a target message based on the invitation message, the expiration time, and the first sending time, and then sending the target message to the first client.

In some embodiments, the above step 109 can alternatively comprise the server sending a target message to the first client based on the invitation message and the expiration time, or the server sending a target message to the first client based on the invitation message and other information, which can be determined according to actual situations and is not limited here.

The above step 108 can be specifically implemented as the following step 108a.

108a: the server calculates the expiration time based on the total valid duration, the first receiving time, and the second preset duration.

Wherein, the second preset duration can be determined based on actual situations, and is not limited here. The second preset duration can be updated periodically to ensure the accuracy of the second preset duration.

It can be understood that the expiration time is the sum of the first receiving time and the total valid duration minus the second duration threshold.

It can be understood that the server includes a business service module for processing business and a message sending and receiving module (such as an instant messaging module) for sending and receiving messages. The first sending time described above is the time when the message sending and receiving module sends the target message. The second preset duration described above is statistically the average duration between the time when the second client sends the second message and the time when the sending and receiving module receives the second message in history, indicating the time taken from the second client sending the invitation message to the server receiving the invitation message.

It should be noted that the time taken from the second client sending the second message (invitation message) to the message sending and receiving module receiving the second message (invitation message) is generally short, usually a few hundred milliseconds, and can therefore be ignored. That is to say, the second duration threshold is relatively small, which has little effect on the calculation of the remaining valid duration.

In embodiments of the present disclosure, the remaining valid duration is calculated based on the total valid duration, the first receiving time, and the second preset duration, which can ensure that the calculated remaining valid duration is more accurate, thereby increasing the probability of success in livestream video chat and improving the user experience.

In some embodiments, the total valid duration may be pre-stored in the server or carried in the invitation message.

For example, in step 101, the total valid duration of the invitation message is carried in the invitation message; wherein the server sends a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; in response that the remaining valid duration is less than the first duration threshold, the invitation message is ignored. The time information includes an expiration time obtained by the server based on the total valid duration and the first receiving time of the invitation message.

In embodiments of the present disclosure, the total valid duration is carried in the invitation message to ensure the accuracy of the total valid duration.

In some embodiments, the remaining valid duration may be a time period between the time when the first client receives the invitation message and the time when the invitation message expires, i.e., a time difference between the time when the invitation message expires and the time when the first client receives the invitation message. Wherein, the expiration time can be calculated by the second client based on the sending time of the invitation message and the total valid duration of the invitation message, and is carried in the invitation message; The expiration time of the invitation message is calculated by the server based on the time of receiving the invitation message and the total valid duration of the invitation message, or by the server based on the time of receiving the invitation message, a second preset duration, and the total valid duration of the invitation message. The expiration time can also be calculated by the first client based on the sending time of the invitation message and the total valid duration of the invitation message. In this case, the sending time of the invitation message is carried in the invitation message, and the total valid duration of the invitation message can be stored in the first client or carried in the invitation message.

In embodiments of the present disclosure, multiple methods for calculating the remaining valid duration are provided, which can be determined based on actual situations and is not limited here.

In some embodiments, the time information may include a total valid duration of the invitation message, a first receiving time at which the server receives the invitation message, and a first sending time at which the server sends the target message. Therefore, after receiving the target message, the first client determines the remaining valid duration based on the total valid duration, the first receiving time, and the first sending time.

In some embodiments, the time information may include a total valid duration of the invitation message, a first receiving time at which the server receives the invitation message, a first sending time at which the server sends the target message, and a first duration threshold. Therefore, after receiving the target message, the first client determines the remaining valid duration based on the total valid duration, the first receiving time, the first sending time, and the first duration threshold.

In some embodiments, the time information may include a total valid duration of the invitation message, a first receiving time at which the server receives the invitation message, and a first sending time at which the server sends the target message, a first duration threshold, and a second duration threshold. Therefore, after receiving the target message, the first client determines the remaining valid duration based on the total valid duration, the first receiving time, the first sending time, the first duration threshold, and the second duration threshold.

For the total valid duration, the first receiving time, the first sending time, the first duration threshold, the second duration threshold, the remaining valid duration, reference can be made to the relevant description above, which will not be repeated here.

In some embodiments, after step 105, the message processing method provided in embodiments of the present disclosure may further include the following step 110.

110: in response that the remaining valid duration is greater than or equal to the first duration threshold, display an expiration reminder message.

Wherein, the expiration reminder message indicates that the invitation message will expire after a target duration. The target duration can be determined based on actual situations, and is not limited here. The target duration is less than or equal to the remaining valid duration.

In embodiments of the present disclosure, by displaying an expiration reminder message, the user can be effectively prompted to determine whether to join a live interaction with the second client based on the invitation message, and trigger the first client to send a reply message (i.e. increase the probability of the reply message reaching the invitee before the invitation message expires by reducing the user's response time), thereby improving the success rate of livestream video chat establishment.

In some embodiments, in response that the remaining valid duration is greater than or equal to the second duration threshold, the target duration is the second duration threshold, the first duration threshold being less than the second duration threshold; alternatively, in response that the remaining valid duration is greater than or equal to the first duration threshold and less than the second duration threshold, the target duration is the remaining valid duration.

Wherein, the second duration threshold can be determined based on actual situations, and is not limited here.

For example, the total valid duration is 20 s, the first duration threshold is 5 s, and the second duration threshold is 10 s. In response that the remaining valid duration is less than 5 s, the first client ignores the invitation message and does not process it; and in response that the remaining valid duration is greater than or equal to 5 s and less than 10 s, the first client displays the invitation message and displays that the invitation message will expire after the remaining valid duration; in response that the remaining valid duration is greater than or equal to 10 seconds, the first client displays the invitation message, and displays that the invitation message will expire after 10 s.

In embodiments of the present disclosure, the user can be prompted in a better manner by providing a second duration threshold. The probability of the reply message reaching the invitee before the invitation message expires is increased by reducing the user's response time, and thereby improving the success rate of livestream video chat establishment.

In some embodiments, the step 110 may alternatively comprise: in response that the remaining valid duration is greater than or equal to the first duration threshold, and less than or equal to a third duration threshold, displaying an expiration reminder message. In this way, the expiration reminder message is displayed when the remaining valid duration is short, and is not displayed when the remaining valid duration is sufficient.

In some embodiments, the first client may update the remaining valid duration over time after determining the remaining valid duration. Specifically, the remaining valid duration can be updated based on the remaining valid duration, the time at which the target message is received, and the current time (the updated remaining valid duration is the difference between the remaining valid duration and a second difference that is the difference between the current time and the time at which the target message is received). In this way, the expiration reminder message is displayed in response that the updated remaining valid duration is short, and is not displayed in response that the updated remaining valid duration is sufficient, so that the user can be reminded in a timely manner without being unduly disturbed.

FIG. 2 is a structural block diagram of a message processing apparatus provided by embodiments of the present disclosure. As shown in FIG. 2, the message processing apparatus comprises: a receiving module 201, an acquiring module 202, and a processing module 203. The receiving module 201 is used for receiving a target message sent by a server, the target message comprising: an invitation message for indicating that the second client invites the first client to join a live interaction. The acquiring module 202 is used for obtaining a remaining valid duration corresponding to the invitation message based on time information carried in the target message that is received by the receiving module 201. The processing module 203 is used for, in response that the remaining valid duration obtained by the acquiring module 202 is greater than or equal to a first duration threshold, displaying the invitation message and sending a reply message based on the invitation message, which indicates whether to agree to join a live interaction with the second client; and in response that the remaining valid duration obtained by the acquiring module 202 is less than the first duration threshold, ignoring the invitation message.

In some embodiments, the time information includes an expiration time of the invitation message and a first sending time at which the target message is sent by the server. The acquiring module 202 is particularly used for determining the remaining valid duration based on the expiration time and the first sending time; wherein, the expiration time is obtained by the server based on a total valid duration of the invitation message and a first receiving time at which the invitation message is received by the server.

In some embodiments, the acquiring module 202 is particularly used for determining the remaining valid duration based on the expiration time, a first sending time, and a first preset duration, wherein the first preset duration is statistically an average duration between the time the server sends the first message to the first client and the time the first client receives the first message.

In some embodiments, the server obtains the expiration time based on the total valid duration, a first receiving time, and a second preset duration, wherein the second preset duration is statistically an average duration between the time the second client sends a second message to the server and the time the server receives the second message.

In some embodiments, the processing module 203 is further used for displaying an expiration reminder message if the remaining valid duration is greater than or equal to a first duration threshold, indicating that the invitation message will expire after a target duration.

In some embodiments, in response that the remaining valid duration is greater than or equal to a second duration threshold, the target duration is the second duration threshold, the first duration threshold being less than the second duration threshold; in response that the remaining valid duration is greater than or equal to the first duration threshold and less than the second duration threshold, the target duration is the remaining valid duration.

The various modules in embodiments of the present disclosure can implement the message processing method provided in the above method embodiment, and can achieve the same technical effect, which will not be repeated here to avoid repetition.

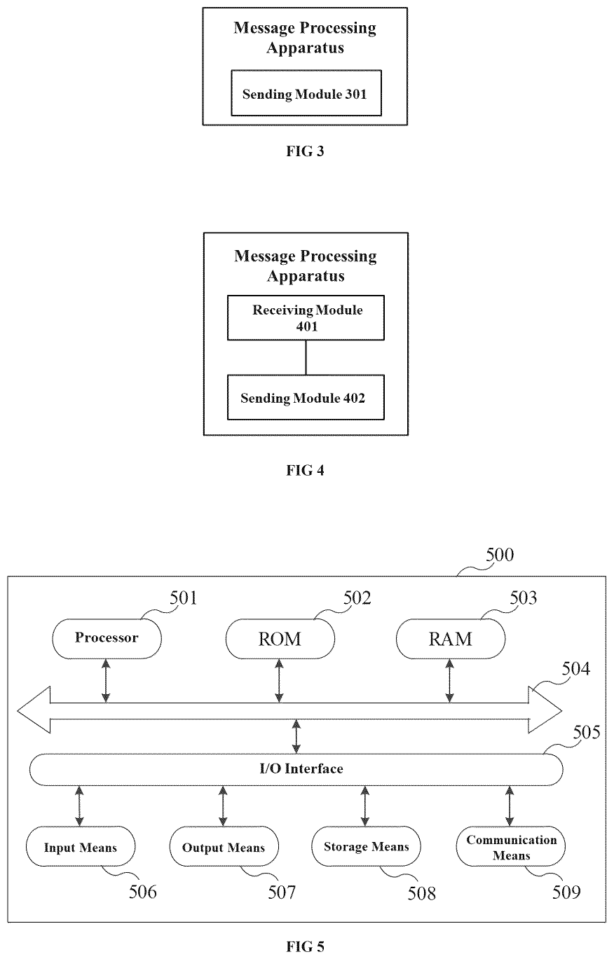

FIG. 3 is a structural block diagram of a message processing apparatus provided by embodiments of the present disclosure. As shown in FIG. 3, the message processing apparatus comprises: a sending module 301 for sending an invitation message to a server, wherein the invitation message indicates that a second client invites a first client to join a live interaction; wherein the server sends a target message to the first client based on the invitation message, the target message being used to enable the first client to obtain a remaining valid duration corresponding to the invitation message based on time information carried in the target message; in response that the remaining valid duration is greater than or equal to a first duration threshold, the invitation message is displayed; in response that the remaining valid duration is less than the first duration threshold, the invitation message is ignored.

In some embodiments, the total valid duration of the invitation message is carried in the invitation message.

In some embodiments, the time information includes an expiration time obtained by the server based on a total valid duration and a first receiving time of the invitation message.

The various modules In embodiments of the present disclosure can implement the message processing method provided in the above method embodiment, and can achieve the same technical effect, which will not be repeated here to avoid repetition.

FIG. 4 is a structural block diagram of a message processing apparatus provided by embodiments of the present disclosure. As shown in FIG. 4, the message processing apparatus comprises: a receiving module 401 and a sending module 402; the receiving module 401 is used for receiving an invitation message sent by a second client, wherein the invitation message indicates that the second client invites a first client to join a live interaction. The sending module 402 is used for sending a target message to the first client based on the invitation message received by the receiving module 401, the target message being used to enable the first client to obtain a remaining valid duration corresponding to the invitation message based on time information carried in the target message, wherein if the remaining valid duration is greater than or equal to a first duration threshold, the invitation message is displayed; if the remaining valid duration is less than the first duration threshold, the invitation message is ignored.

In some embodiments, the time information includes an expiration time of the invitation message and a first sending time at which the target message is sent by the server. The sending module is particularly used for determining the expiration time based on a total valid duration of the invitation message and a first receiving time at which the invitation message is received, and sending the target message to the first client based on the invitation message, the expiration time, and the first sending time.

In some embodiments, the server obtains the expiration time based on the total valid duration, a first receiving time, and a second preset duration, wherein the second preset duration is statistically an average duration between the time the second client sends a second message to the server and the time the server receives the second message.

The various modules in embodiments of the present disclosure can implement the message processing method provided in the above method embodiment, and can achieve the same technical effect, which will not be repeated here to avoid repetition.

According to some embodiments of the present disclosure, there is further provided a computer program, comprising: instructions that, when executed by a processor, cause the processor to perform the message processing method described above.

FIG. 5 is a schematic structure diagram of a communication device provided by embodiments of the present disclosure, for illustrating the communication device implementing the message processing method provided by any embodiment of the present disclosure, and should not be understood as a specific limitation of the embodiments of the present disclosure.

As shown in FIG. 5, the communication device 500 may include a processor (e.g., a central processing unit, a graphics processor) 501, which may perform various appropriate actions and processes according to a program stored in Read Only Memory (ROM) 502 or a program loaded from storage device 508 into Random Access Memory (RAM) 503. In RAM 503, various programs and data required for the operation of the communication device 500 are also stored. The processor 501, ROM 502, and RAM 503 are connected to each other through a bus 504. An input/output (I/O) interface 505 is also connected to the bus 504.

Generally, the following devices can be connected to I/O interface 505: input means 506 including, for example, a touch screen, a touch pad, a keyboard, a mouse, a camera, a microphone, an accelerometer, a gyroscope, etc; output means 507 including a liquid crystal display (LCD), a speaker, a vibrator, etc.; a storage means 508 such as a magnetic tape, a hard disk, etc; and a communication means 509. The communication means 509 enables the communication device 500 to communicate in a wireless or wired manner with other means to exchange data. Although FIG. 5 shows the communication device 500 with various means, it should be understood that it is not required to implement or have all of these means. Alternatively, more or fewer means can be implemented or provided.

In particular, according to embodiments of the present disclosure, the processes described above with reference to the flowchart can be implemented as a computer software program. For example, embodiments of the present disclosure include a computer program product, which include a computer program carried on a non-transitory computer readable medium, and containing program code for executing the method shown in the flowchart. In such embodiments, the computer program may be downloaded and installed from the network through the communication means 509, or installed from the storage means 508, or from the ROM 502. When the computer program is executed by the processor 501, the above functions defined in the message processing method provided by any embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks include a local area network (“LAN”) and a wide area network (“WAN”), the Internet, and end-to-end networks (for example, ad hoc end-to-end networks), as well as any currently known or future developed networks.

The above computer readable medium may be included in the communication device described above; or it may exist alone without being assembled into the communication device.

The computer readable medium carries one or more programs that, when executed by the communication device (which is a first client), cause the communication device to perform steps of: receiving a target message sent by a server, the target message comprising: an invitation message for indicating that a second client invites a first client to join a live interaction; based on time information carried in the target message, acquiring a remaining valid duration corresponding to the invitation message; in response that the remaining valid duration is greater than or equal to a first duration threshold, displaying the invitation message, and sending a reply message based on the invitation message, which indicates whether to agree to join a live interaction with the second client; in response that the remaining valid duration is less than the first duration threshold, ignoring the invitation message.

The computer readable medium carries one or more programs that, when executed by the communication device (which is a second client), cause the communication device to perform steps of: sending an invitation message to a server, wherein the invitation message indicates that a second client invites a first client to join a live interaction; wherein the server sends a target message to the first client based on the invitation message, the target message being used to enable the first client to obtain a remaining valid duration corresponding to the invitation message based on time information carried in the target message; in response that the remaining valid duration is greater than or equal to a first duration threshold, the invitation message is displayed; in response that the remaining valid duration is less than the first duration threshold, the invitation message is ignored.

Alternatively, the computer readable medium carries one or more programs that, when executed by the communication device (which is a server), cause the communication device to perform steps of: receiving an invitation message sent by a second client, wherein the invitation message indicates that the second client invites a first client to join a live interaction; sending a target message to the first client based on the invitation message, the target message being used to enable the first client to obtain a remaining valid duration corresponding to the invitation message based on time information carried in the target message; in response that the remaining valid duration is greater than or equal to a first duration threshold, displaying the invitation message; in response that the remaining valid duration is less than the first duration threshold, ignoring the invitation message.

In the present disclosure, computer program code for executing operations of the present disclosure may be complied by any combination of one or more program design languages, the program design languages including, but not limited to, object-oriented program design languages, such as Java, Smalltalk, C++, etc, as well as conventional procedural program design languages, such as “C” program design language or similar program design language. The program code may be completely or partly executed on a computer, or executed as an independent software package, partly executed on the computer and partly executed on a remote computer, or completely executed on a remote computer or server. In the latter circumstance, the remote computer may be connected to a computer through various kinds of networks, including local area network (LAN) or wide area network (WAN), or connected to an external computer (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. Wherein, the names of the units do not constitute a limitation on the units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a computer-readable medium may be a tangible medium, which may contain or store a program for use by or in connection with an instruction execution system, apparatus, or device. The computer readable medium can be a computer readable signal medium or a computer readable storage medium. The computer readable medium may include, but is not limited to, an electronic, magnetic, optical, electromagnetic, infrared, or semiconductor system, apparatus, or device, or any suitable combination of thereof. More specific examples of the computer readable storage medium may include electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A message processing method applicable to a first client, comprising:
receiving a target message sent by a server, the target message comprising: an invitation message for indicating that a second client invites the first client to join a live interaction;
acquiring a remaining valid duration corresponding to the invitation message based on time information carried in the target message;
in response that the remaining valid duration is greater than or equal to a first duration threshold, displaying the invitation message to send a reply message based on the invitation message, wherein the reply message indicates whether to agree to join a live interaction with the second client; and
in response that the remaining valid duration is less than the first duration threshold, ignoring the invitation message.

2. The message processing method according to claim 1, wherein the time information includes an expiration time of the invitation message and a first sending time at which the target message is sent by the server;
the acquiring a remaining valid duration corresponding to the invitation message based on time information carried in the target message comprises:
determining the remaining valid duration based on the expiration time and the first sending time;
wherein the expiration time is obtained by the server based on a total valid duration of the invitation message and a first receiving time at which the invitation message is received by the server.

3. The message processing method according to claim 1, wherein the remaining valid duration is a first difference between the expiration time and the first sending time.

4. The message processing method according to claim 2, wherein determining the remaining valid duration based on the expiration time and the first sending time comprises:
determining the remaining valid duration based on the expiration time, the first sending time, and a first preset duration, wherein the first preset duration is statistically an average duration between the time the server sends a first message to the first client and the time the first client receives the first message.

5. The message processing method according to claim 4, wherein the remaining valid duration is a difference between a first difference and the first preset duration, wherein the first difference is a difference between the expiration time and the first sending time.

6. The message processing method according to claim 2, wherein the remaining valid duration is a product of a first difference and a preset value, wherein the first difference is a difference between the expiration time and the first sending time, and the preset value is greater than 0 but less than 1.

7. The message processing method according to claim 2, wherein the expiration time is obtained by the server based on the total valid duration, the first receiving time, and a second preset duration, wherein the second preset duration is statistically an average duration between the time the second client sends a second message to the server and the time the server receives the second message.

8. The message processing method according to claim 1, further comprising:
in response that the remaining valid duration is greater than or equal to the first duration threshold, displaying an expiration reminder message, the expiration reminder message being used to indicate that the invitation message will expire after a target duration that is less than or equal to the remaining valid duration.

9. The message processing method according to claim 8, wherein
in response that the remaining valid duration is greater than or equal to a second duration threshold, the target duration is the second duration threshold, the first duration threshold being less than the second duration threshold; or
in response that the remaining valid duration is greater than or equal to the first duration threshold and less than the second duration threshold, the target duration is the remaining valid duration.

10. A message processing method applicable to a second client, comprising:
sending an invitation message to a server, wherein the invitation message indicates that the second client invites a first client to join a live interaction;
wherein the invitation message is used by the server to send a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; and in response that the remaining valid duration is less than the first duration threshold, the invitation message is ignored.

11. The message processing method according to claim 10, wherein a total valid duration of the invitation message is carried in the invitation message.

12. A message processing method applicable to a server, comprising:
receiving an invitation message sent by a second client, wherein the invitation message indicates that the second client invites a first client to join a live interaction;
sending a target message to the first client based on the invitation message, the target message being used to enable the first client to acquire a remaining valid duration corresponding to the invitation message based on time information carried in the target message; in response that the remaining valid duration is greater than or equal to a first duration threshold, the invitation message is displayed; and in response that the remaining valid duration is less than the first duration threshold, the invitation message is ignored.

13. The message processing method according to claim 12, wherein the time information includes an expiration time of the invitation message and a first sending time at which the target message is sent by the server;
sending a target message to the first client based on the invitation message comprises:
determining the expiration time based on a total valid duration of the invitation message and a first receiving time at which the invitation message is received; and
sending the target message to the first client based on the invitation message, the expiration time, and the first sending time.

14. The message processing method according to claim 13, wherein the server obtains the expiration time based on the total valid duration, the first receiving time, and a second preset duration, wherein the second preset duration is statistically an average duration between the time the second client sends a second message to the server and the time the server receives the second message.

15-21. (canceled)

22. A communication device, comprising:
a memory for storing computer programs; and
a processor for performing, by invoking the computer programs, the message processing method according to claim 1.

23. A communication device, comprising:
a memory for storing computer programs; and
a processor for performing, by invoking the computer programs, the message processing method according to claim 10.

24. A communication device, comprising:
a memory for storing computer programs; and
a processor for performing, by invoking the computer programs, the message processing method according to claim 12.

25. A non-transitory computer-readable storage medium on which a computer program is stored, wherein the computer program when executed by a processor, implements the message processing method according to claim 1.

26. A non-transitory computer-readable storage medium on which a computer program is stored, wherein the computer program when executed by a processor, implements the message processing method according to claim 10.

27. A non-transitory computer-readable storage medium on which a computer program is stored, wherein the computer program when executed by a processor, implements the message processing method according to claim 12.
